(19) United States
(12) Patent Application Publication
(10) Pub. No.: US 2010/0255169 A1
(43) Pub. Date: Oct. 7, 2010

(54) PACKAGE HEATING APPARATUS AND CHEMICAL COMPOSITION

(75) Inventors: Brendan Coffey, Austin, TX (US); Robert John Gordon, Tucson, AZ (US); Donald R. Schropp, JR., Austin, TX (US); Krzysztof Czeslaw Kwiatkowski, Austin, TX (US)

Correspondence Address: PATENT ADMINISTRATOR;NEAL, GERBER, & EISENBERG, SUITE 1700, 2 NORTH LASALLE STREET, CHICAGO, IL, 60602, US

(73) Assignee: Inonbridge Technologies, Inc., Austin, TX (US)

(21) Appl. No.: 12/570,822

(22) Filed: Sep. 30, 2009

Related U.S. Application Data
(63) Continuation-in-part of application No. 12/419,917, filed on Apr. 7, 2009.
(60) Provisional application No. 61/224,395, filed on Jul. 9, 2009.

(51) Int. Cl. A47J 39/00; F24J 1/00

(52) U.S. Cl. 426/523; 126/263.01

(57) ABSTRACT

A heating device is provided comprising a heating chamber for receiving and storing a substance to be heated having at least two walls, a reaction chamber affixed to a wall of the heating chamber, a solid-state modified thermite reaction composition located within the reaction chamber and an actuatable trigger mechanism affixed to the reaction chamber such that the trigger mechanism is in contact with the reaction composition. According to another aspect, a heating device is provided comprising a heating chamber defining an interior space for receiving and storing a substance to be heated, a reaction chamber, a solid-state modified thermite reaction composition disposed within the reaction chamber such that it is physically isolated from and in thermal communication with the interior space of the heating chamber and an activator mechanism affixed to either reaction chamber or heating chamber such that the activator mechanism is in communication with the reaction composition.

### CROSS-REFERENCE TO RELATED APPLICATIONS

This application is a Continuation-In-Part of U.S. patent application Ser. No. 12/419,917, filed on Apr. 7, 2009, entitled “Solid-State Thermite Composition Based Heating Device,” and a Non-Provisional Application of U.S. Provisional Patent Application 61/224,395, filed on Jul. 9, 2009 entitled “Solid-State Thermite Composition Based Heating Device,” both upon which a claim of priority is based.

### TECHNICAL FIELD

This disclosure relates to precisely controlled solid-state thermite reaction compositions and incorporation of those compositions into an integrated heating device for various applications such as heating of prepared foods or beverages in their containers.

### BACKGROUND

Situations arise in which it would be convenient to have a distributed means of providing heat in circumstances where heating appliances are not available. For example, producers of prepared foods have indicated that there could be significant market potential for self-heating food packaging (SHFP) systems that could heat prepared foods in their containers to serving temperature, simply, safely, and efficiently.

For a mass consumer SHFP product, safety is paramount and should be inherent; preferably there should be no extreme temperatures, no fire, no smoke or fumes under anticipated use and abuse conditions. Practical considerations mandate that any system be reasonably compact and lightweight with respect to the food to be heated. Thus, the system should have a good specific energy and high efficiency. The system must also be capable of extended storage without significant loss of function or accidental activation of the heater. There should be some simple means of activating the heating component of the system, after which the required heat load should be delivered efficiently within a specified time period, perhaps just a few minutes. Operation must be very reliable with low failure rates in millions of units of production. For a single use food application, material components should be food-safe, low-cost, environmentally friendly and recyclable.

The only SHFP technology currently in the consumer market uses an onboard system for mixing separated compartments of quicklime and water, yielding an exothermic heat of solution. These products are bulky (literally doubling package size and weight), complex, unreliable, costly, and have achieved very low market penetration. There have also been reported instances of the heater solution leaking and coming into contact with food or consumers.

An exothermic reaction in which the component reactants could be premixed yet be inert until such time as the user initiates the reaction would be beneficial in terms of providing for a simpler, more compact, and low cost package design. A solid-state reaction system could offer advantage over wet chemical systems since solid systems will be less prone to spill or leak.

Thermites are a class of exothermic solid-state reactions in which a metal fuel reacts with an oxide to form the more thermodynamically stable metal oxide and the elemental form of the original oxide. Thermites are formulated as a mechanical mix of the reactant powders in the desired stoichiometric ratio. The powders may be compressed into a unitary mass. These compact reactions generate substantial heat, with system temperatures that can reach several thousand degrees, often high enough to melt one or more of the reagents involved in the reaction. However, thermite reactions typically require a very high activation energy (e.g., welding thermites [Al/FeOₓ] are ignited with a burning magnesium ribbon). Thus, a thermite reagent composition can be formulated to be quite stable to prevent inadvertent initiation due to electrostatic shock or mechanical impact. This generally inert character is an advantage in storage and transportation.

The most widely known thermite system is the Al/FeOₓ system described in Table 1. Once initiated, this system reacts virtually instantaneously to generate molten iron and is in fact used for welding rail lines. The only other significant known applications of thermites are in pyrotechnics and military weapons technologies. “A Survey of Combustible Metals, Thermites, and Intermetallics for Pyrotechnic Applications,” S. H. Fischer, M. C. Grubelich, Proc. Of 32^{nd} AIAA/ASME/SAE/ASEE Joint Propulsion Conference (1996) and “Thermite Reactions: their utilization in the synthesis and processing of materials,” L. L. Wang, Z. A. Munir, Y. M. Maximov, Journal of Material Science 28(14), 3693-3708 (1993) provide useful surveys of various classes of solid-state reactions including thermites.

TABLE 1
Characteristics of FeOx/Al and SiO2/Al Thermite Reactions

| | | | Adiabatic | | Gas |
|---|---|---|---|---|---|
| | | Heat of | Reaction | | production |
| | Density | reaction | Temperature | | (moles of gas |
| Reaction | (g cm⁻³) | (kJ g⁻¹) | (K) | State of Products | per 100 g) |
| 2Al + Fe₂O₃→ | 4.175 | 3.95 | 3135 | molten Al₂O₃ slag | 0.1404 |
| 2Fe + Al₂O₃ | | | (2862° C.) | Fe (liq./gas) | |
| 8Al + 3Fe₃O₄ → | 4.264 | 3.67 | 3135 | Molten Al₂O₃ slag | 0.0549 |
| 9Fe + 4Al₂O₃ | | | (2862° C.) | Fe (liq./gas) | |
| 4Al + 3SiO₂ → | 2.668 | 2.15 | 1889 | solid Al₂O₃ | 0 |
| 3Si + 2Al₂O₃ | | | (1616° C.) | Si (liq.) | |

Since thermite reactions are generally vigorous with intense heat, they have not yet been successfully adapted for moderate-temperature consumer applications. Therefore, it would be highly beneficial to harness the energy release from a kinetically moderated thermite reaction thus transforming a reaction with generally pyrotechnic character to a precisely controlled power source for thermal energy and to then integrate that thermal energy into a heating device for consumer applications.

### SUMMARY

A solid-state modified thermite reaction composition is provided comprising a fuel component, a primary oxidizer, one or more initiating oxidizers and a thermal diluent. The composition can be further comprised of a fluxing agent. The composition can also further be comprised of a high energy oxidizer.

According to another aspect, a heating device or package is provided comprising a heating chamber defining an interior space for receiving and storing a substance to be heated, a reaction chamber disposed adjacent to the interior space of the heating chamber, a solid-state modified thermite reaction composition disposed within the reaction chamber such that it is physically isolated from and in thermal communication with the interior space of the heating chamber; and an activator mechanism connected to either the reaction chamber or the heating chamber such that the activator mechanism is in communication with the reaction composition; wherein the reaction composition is inert until the activator mechanism is actuated.

According to another aspect, a solid-state modified thermite reaction activation mechanism is provided comprising a first compound substantially in contact with a modified thermite reaction fuel, a second compound and a removable barrier located between the first and second compounds preventing any contact between the first and second compounds. When the barrier is removed, the first and second compounds contact one another and generate heat sufficient to initiate a thermite reaction using the modified thermite reaction fuel.

Other aspects will be apparent to those of ordinary skill in the art upon consideration of the description, drawings and claims that follow.

### BRIEF DESCRIPTION OF THE DRAWINGS

To understand the present invention, it will now be described by way of example, with reference to the accompanying drawings in which:

FIG. 1 is a perspective cross-sectional view of an illustrative embodiment of a food packaging application with an integrated solid-state modified thermite heating element;

FIG. 2 is a perspective cross-sectional view of the heating element depicted in FIG. 1;

FIG. 3 is a side cross-sectional view of another illustrative embodiment of a food packaging application with an integrated solid-state modified thermite heating element;

FIG. 4 is a side cross-sectional view of an illustrative embodiment of a re-useable bowl with a port to removably insert a solid-state modified thermite heating element;

FIG. 5 is a side cross-sectional view of the embodiment of FIG. 4 with a re-useable activation mechanism removably attached;

FIG. 6 is a perspective cross-sectional view of a solid-state modified thermite activation mechanism with a tear-off seal;

FIG. 7 is a perspective cross-sectional view of a solid-state modified thermite activation mechanism with a foil barrier and foil piercing element;

FIG. 8 is a side cross-sectional view of a solid-state modified thermite activation mechanism with a membrane coated with activation reagents on both sides;

FIG. 9 is a side cross-sectional view of a solid-state modified thermite activation mechanism with a peizoelectric spark ignitor;

FIG. 10 is a graphical depiction of a least squares fit of thermite reaction flame position versus time data;

FIG. 11 is a graphical depiction of calorimetry data of solid-state thermite reactions.

FIG. 12A is a perspective view of an embodiment of the present invention.

FIG. 12B is a side cross-sectional view of the embodiment of FIG. 12A.

FIG. 12C is a side cross-sectional view of the embodiment of FIG. 12A.

FIG. 12D is a perspective cross-sectional view of the embodiment of FIG. 12A.

FIG. 12E is a top view of an embodiment of the present invention.

FIG. 12F is a side view of the embodiment of FIG. 12E.

FIG. 12G is a perspective view of the embodiment of FIG. 12E.

FIG. 12H is a perspective view of an embodiment of the present invention.

FIG. 12I is a top cross-sectional view of the embodiment of FIG. 12H.

FIG. 12J is a side cross-sectional view of the embodiment of FIG. 12H.

FIG. 12K is a perspective view of an embodiment of the present invention.

FIG. 12L is a side cross-sectional view of the embodiment of FIG. 12K.

FIG. 12M is a top cross-sectional view of the embodiment of FIG. 12K.

FIG. 13A is a perspective view of an embodiment of the present invention.

FIG. 13B is a side cross-sectional view of the embodiment of FIG. 13A.

FIG. 13C is a side cross-sectional view of the embodiment of FIG. 13A.

FIG. 13D is a perspective view of the embodiment of FIG. 13A.

FIG. 13E is a perspective view of the embodiment of FIG. 13A.

FIG. 13F is a perspective view of the embodiment of FIG. 13A.

FIG. 13G is a perspective view of the embodiment of FIG. 13A.

FIG. 13H is a perspective view of the embodiment of FIG. 13A.

FIG. 13I is a perspective view of an embodiment of the present invention.

FIG. 13J is a top cross-sectional view of the embodiment of FIG. 13I.

FIG. 13K is a perspective cross-sectional view of the embodiment of FIG. 13I.

FIG. 13L is a perspective view of an embodiment of the present invention.

FIG. 13M is a side cross-sectional view of the embodiment of FIG. 13L.

FIG. 13N is a perspective view of an embodiment of the present invention.

FIG. 13O is a side cross-sectional view of the embodiment of FIG. 13N.

FIG. 14A is a top view of an embodiment of the present invention.

FIG. 14B is a perspective view of the embodiment of FIG. 14A.

FIG. 14C is a side view of the embodiment of FIG. 14A.

FIG. 14D is a side cross-sectional view of the embodiment of FIG. 14A.

FIG. 14E is a bottom view of the embodiment of FIG. 14A.

FIG. 14F is a perspective cross-sectional view of the embodiment of FIG. 14A.

FIG. 14G is a perspective cross-sectional view of the embodiment of FIG. 14A.

FIG. 14H is a perspective cross-sectional view of the embodiment of FIG. 14A.

FIG. 15A is a top view of an embodiment of the present invention.

FIG. 15B is a perspective view of the embodiment of FIG. 15A.

FIG. 15C is a side view of the embodiment of FIG. 15A.

FIG. 15D is a bottom view of the embodiment of FIG. 15A.

FIG. 15E is a side cross-sectional view of the embodiment of FIG. 15A.

FIG. 15F is a perspective cross-sectional view of the embodiment of FIG. 15A.

FIG. 15G is a perspective cross-sectional view of the embodiment of FIG. 15A.

FIG. 15H is a side cross-sectional view of a stack of the embodiments of FIG. 15A.

FIG. 16 is a perspective exploded view of an embodiment of the present invention.

### DETAILED DESCRIPTION OF EXEMPLARY EMBODIMENTS

The description that follows describes, illustrates and exemplifies one or more particular embodiments of the present invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the present invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. The present specification is intended to be taken as a whole and interpreted in accordance with the principles of the present invention as taught herein and understood to one of ordinary skill in the art.

Food-safety and cost are two primary considerations in the selection of potential materials for use in the illustrative embodiments described herein. The Al/FeOₓ and Al/SiO₂ thermites described in Table 1 involve only abundant, low-cost, food-safe materials and are therefore in this regard good candidates for SHFP. However, those of ordinary skill in the art will understand that many different materials could be selected without departing from the novel scope of the present invention.

Table 1 compares various characteristics of Al/FeOₓ and Al/SiO₂ thermite systems. In both cases aluminum is the fuel, with either FeOₓ or SiO₂ as oxidizer. However the reaction character of the two systems are distinctly different. The high heat of reaction (3.8 kJ g⁻¹) of the Al/FeOₓ thermite leads to an adiabatic reaction temperature of over 3000 K (well above the melting point of both metals: T_{M, Fe}=1809 K, T_{M, Al}=933 K), with excess heat generating gases that can spew molten reaction product. The heat of reaction for Al/SiO₂ thermite is somewhat lower (2.15 kJ g⁻¹) leading to an adiabatic reaction temperature of only 1889 K. This temperature is insufficient to melt the alumina slag formed during reaction. This slag acts as a thickening barrier to mass transfer in this type of system, and thus, thermal losses at the reaction front can quench the Al/SiO₂ thermite reaction.

The rate-limiting step in thermite reactions is typically diffusion of material to the reaction zone. Accordingly, heat transfer and mass transfer are closely coupled in determining reaction rate. Thermite kinetics are typically modeled as a combustion system in which a solid flame front moves through preheat, reaction and quench zones. For reaction self-propagation to occur, the heat generated in the reaction zone must trigger reaction ahead of the wave front. The parameter used to quantify reaction rate of thermites is combustion wave speed. These can range anywhere from approximately 1 m s⁻¹ for conventional thermites to greater than 1000 m s⁻¹ for superthermites based on nanoscale powdered reactants.

While reasonably exothermic, the Al/SiO₂ system is inherently both non-detonative and self-extinguishing. Based on this more controlled reaction character, this system comprises the foundation of the moderated thermite composition of the embodiments of the present invention described herein. In one embodiment the foundational solid-state chemistry is modulated via a combination of physical and chemical reaction modifiers to prepare Al/SiO₂ thermite fuel formulations that are inherently self-regulating at an optimal bounded temperature and give high utilization of the chemical energy content of the reaction materials at the requisite rate of heating.

Another aspect of these embodiments is maximization of energy content in the solid thermite composition. “Mixed” thermites can be prepared, for example using a combination of oxidizers, and, as shown in Table 1, substituting any portion of the SiO₂ oxidizer with FeOₓ to create a ternary system, which can beneficially increase the specific energy content of the system from approximately 2 to 4 kJ g⁻¹ depending on FeOₓ content. Aluminum, SiO₂, and iron oxides are readily available in various commercial powder grades with food grade purity.

Factors that can be altered to adjust the reaction rate and combustion temperature of thermite systems include: particle size of reactants, composition, diluent (inert) additives, pre-combustion density, ambient pressure and temperature, and physical and chemical stability of reactants.

Because mass diffusion is the rate controlling step for thermites and diffusion-controlled reactions are inherently slower than temperature dependent chemical kinetics, increasing the diffusion coefficient or reducing the diffusion length between fuel and oxidizer species within an energetic composite can be used to accelerate the reaction rate. Particle shape can be highly influential. For efficient thermite fuel utilization, the solid-state reaction must be self-sustaining throughout its volume and there should not be extensive un-reacted regions. Those of ordinary skill in the art will understand that the degree and intimacy of mixing between the silica, aluminum, and additive constituents can be altered to satisfy a myriad of desired outcome parameters without departing from the novel scope of the present invention.

In a preferred embodiment of an Al/SiO₂ thermite fuel formulation as shown in Table 2 below, the thermite fuel is an aluminum flake. In order to achieve an appropriate balance of reactive surface area and relatively low thermal conductivity to reduce combustion rate, a portion of the silica used is fumed silica, which is in fact an agglomerated nanoparticulate that is easily dispersed into mixtures. Certain materials can act as a “coolant” to lower the burning temperature of the mixture and/or slow down the reaction rate. Other additives can act as binders or stabilizers to regulate mass and heat transfer. Accordingly, in a particular embodiment, a nanoscale clay material is used as a thermal buffer to moderate temperature. Other materials may be used as well.

In order to render self-sustaining character to the Al/SiO₂ system while operating at lower temperatures, an accelerant is incorporated to reduce the activation energy for the reaction or enable a lower energy reaction path. For example, as shown in Table 2, potassium chlorate, a strong oxidizer is used as an accelerant. Those of ordinary skill in the art will understand that there are many other possible chemical accelerants that could be incorporated without departing from the novel scope of the present invention. Further, the high boiling point, inert salt calcium fluoride is provided as a fluxing agent to increase the fluidity of the reacting system and thereby facilitate mass transport.

TABLE 2
Compositions in Weight Percent for Examples

| | | Example I | Example II |
|---|---|---|---|
| Component | Function | (BC03A04) | (BC12A02) |
| Flaked Aluminum | Fuel component | 17.9% | 17.3% |
| powder (Toyal America | | | |
| 5621) | | | |
| KClO₃ | Initiating oxidizer | 14.3% | 13.8% |
| (Sigma-Aldrich 31247) | | | |
| SiO₂−325 mesh | Oxidizer, dense | 17.9% | 13.0% |
| (Sigma-Aldrich 342890) | form | | |
| Fumed silica | Oxidizer, high | 3.5% | 3.5% |
| (Sigma-S5130) | surface area form | | |
| CaF₂ | Fluxing agent | 10.7% | 10.4% |
| (Sigma-Aldrich 31247) | | | |
| Bentonite nanoclay | Thermal Diluent | 35.7% | 34.3% |
| (Aldrich 682659) | | | |
| Fe₂O₃ < 5 micron | High energy | 0% | 7.7% |
| (Sigma-Aldrich 31247) | oxidizer | | |

The exemplary thermite fuel compositions described above were tested to determine their specific energy and reaction rate as follows:

### Example I

### Specific Energy and Reaction Rate Determination on a Moderated Al/SiO2 Thermite—Initiated By Hot Wire

An approximately 30 g batch of the formulation in column 3 of Table 2 is prepared using the following steps. The powdered components are all first sieved through a 60-mesh screen and weighed in correct proportions into a mill jar. They are mixed in the jar by tumbling on a roll mill for 30 minutes.

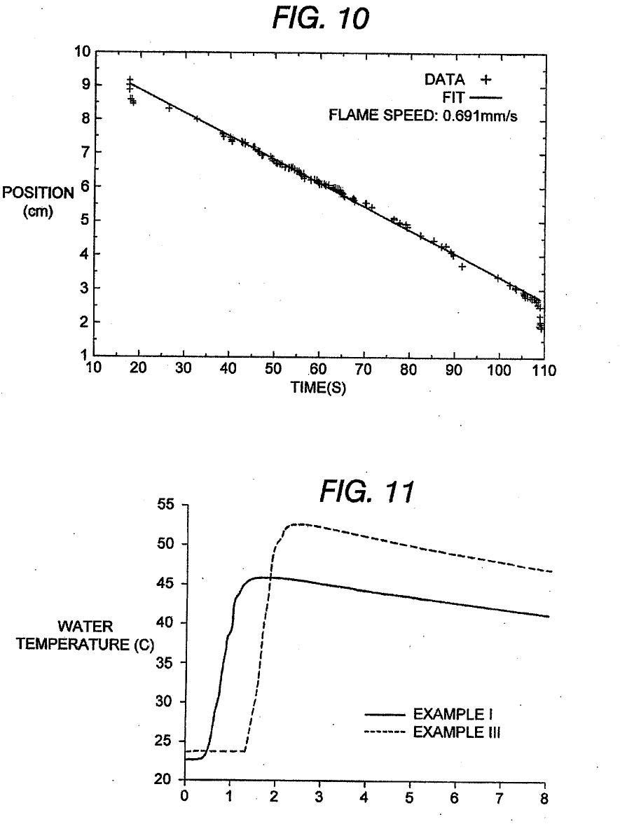

As discussed previously, the rate of reaction and hence heat generation or power is a key metric for an energetic material in consumer heating applications. Kinetic measurements were made on the Example I material by flame tube experiments in which the energetic material is placed in a Pyrex tube and initiated with a hot wire. A video of the reaction is made and then the position data of the reaction front versus time are least square analyzed to extract reaction propagation velocity. FIG. 10 shows the reaction propagation velocity for the Example I material to be 0.691 mm s⁻¹. This low combustion rate is significantly below that previously reported for conventional thermite reactions and allows efficient calorimetric heat transfer to take place.

Calorimetric data was measured on a sample prepared by packing approximately 7 g of the powder mix into an open top cylindrical steel can (14 mm diameter×50.5 mm high). The filled can is held immersed in a stirred beaker containing approximately 120 g of water. A small nichrome wire heating element connected to a current source is placed in contact with the upper surface of the packed powder. Current is passed momentarily to initiate the mix and then switched off. The temperature of the water vs. time is recorded, and the maximum temperature increase is used to calculate the thermal energy transferred to the water. The curve labeled Example I on FIG. 11 shows calorimetric time vs. temperature data on the Example I formulation. With the Example I formulation, it takes less than 2 minutes for the water to reach its peak temperature and deliver an energy content of 1.61 kJ g⁻¹.

### Example II

### Specific Energy Determination on a Moderated Al/SiO₂ Thermite Containing Fe₂O₃—Initiated By Hot Wire

Example II is prepared in a similar manner and tested as Example I except that some stoichiometric fraction of the SiO₂ in the formulation is replaced by Fe₂O₃ to yield the formulation given in Column 4 of Table 2. The curve labeled Example II on FIG. 11 shows calorimetric time vs. temperature data on the Example II formulation. The greater specific oxidizing power of the Fe₂O₃ substituent is evidenced by a higher peak temperature of the water. This corresponds to a transferred energy content of 1.76 kJ g⁻¹.

Another embodiment of the present invention is the inclusion of a means for activating a solid-fuel modified thermite composition. The solid fuel should not be prone to inadvertent activation, yet a simple means of activating the reactive material in the heater at the desired time of use is beneficial.

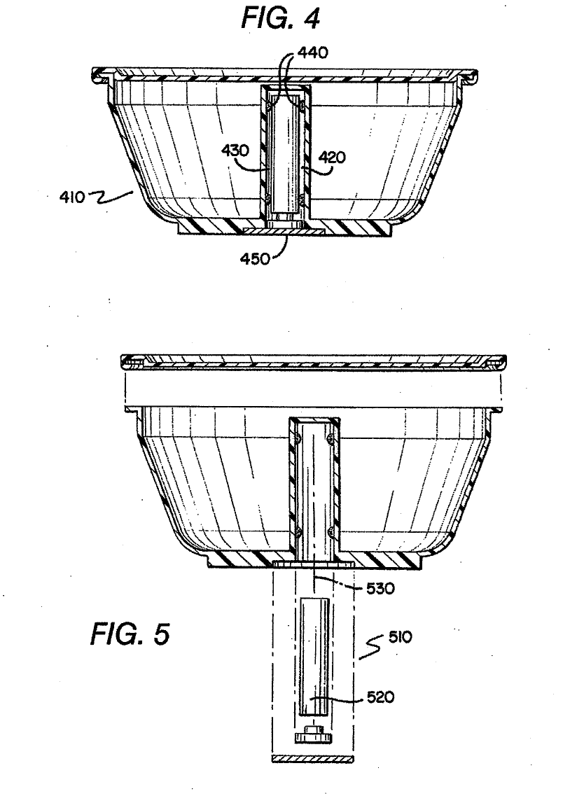

In some embodiments, a more complex and costly activation device that is re-useable would couple to disposable heater elements for activation. For example, as shown in FIGS. 4 and 5, a re-useable container is provided with a re-useable activating device such as a battery powered hot wire or a piezoelectric spark ignitor, as shown in FIG. 9. Referring to FIG. 4, a heating bowl 410 is provided with a port 420 to receive heating elements 430 containing a solid-state modified thermite fuel composition. The heating element 430 is held in place by holding tabs or standoffs 440. An activation device port 450 is provided on the bottom of the bowl to receive and temporarily attach a modified thermite activation device. The activation device could be a simple battery and wire device 510 as shown in FIG. 5. The battery 520 is connected to a wire 530 that can be extended through the activation device port 450 into the modified thermite fuel composition within the heating element 430. The battery can be used to send enough current down the wire to initiate a thermite reaction using the modified thermite fuel composition. In addition, the activation device could be a piezoelectric spark ignitor as shown in FIG. 9. Those of ordinary skill in the art will understand that many types of activation devices can be employed without departing from the novel scope of the present invention.

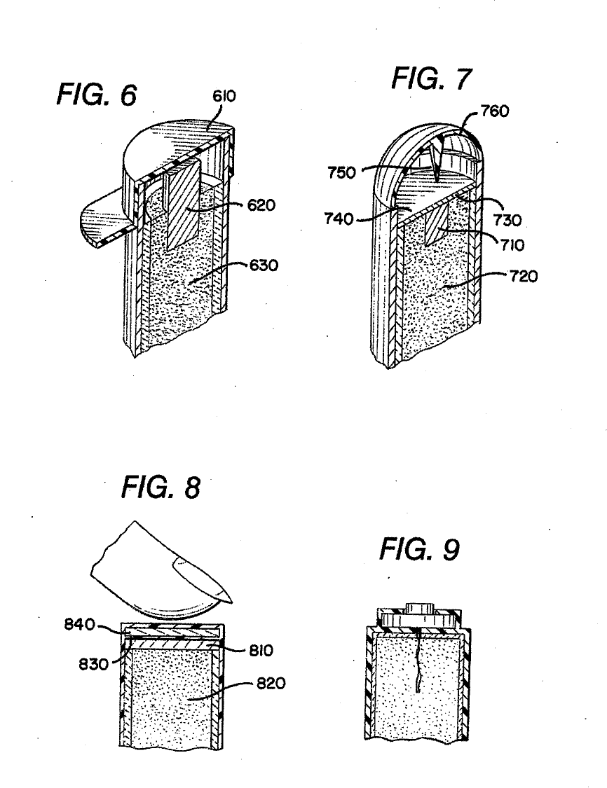

In a particular embodiment that enables the greatest ease of use, a simple, low-cost, small (or even miniature) activation device as a built-in component of the heating device is provided. This embodiment is particularly useful in the disposable food packaging context. For example, as shown in FIGS. 6, 7 and 8, the activation device could be comprised of minute quantities of an exothermic A/B chemical couple separated by a partition. When the partition is breached mechanically by a simple action of the user, the reactive A/B components mix into contact with each other as well as with the bulk solid modified thermite fuel composition. Reaction of the A/B components generates a highly localized hot spot in contact with the fuel composition, thereby initiating its controlled combustion.

While those of ordinary skill in the art will understand that there are many exothermic couples that can be used, FIGS. 6, 7 and 8 show three designs that incorporate reagents which produce sufficient heat to activate thermite reactions. FIG. 6 shows a pyrophoric iron/air couple where the removal of an internal seal 610 exposes a small mass of pyrophoric iron 620, which is in contact with a solid modified thermite fuel composition 630, to the surrounding atmosphere. The pyrophoric iron reacts with the air to generate the requisite heat to initiate the thermite reaction.

A potassium permanganate/glycerin couple, as shown in FIG. 7, is easily prepared, low-cost and food-safe while reliably generating very high temperatures with minute quantities of reagents. FIG. 7 shows an amount of potassium permanganate 710 placed directly onto the modified thermite fuel composition 720. An aluminum foil barrier 730 is placed over the potassium permanganate 710 and glycerin 740 is placed onto the foil. A cover 760 made of a malleable material with an integrated piercing member 750 is placed over the entire system. A user can then activate the mechanism by pressing down on the cover 760 thus pushing the piercing member 750 through the foil barrier 730, allowing the potassium permanganate 710 and glycerin 740 to mix and generate enough heat to initiate the thermite reaction.

This embodiment is capable of being produced in high volume based on a multi-laminate paper making process in which a thin septum layer is interposed between sheets coated with each reactant as shown in FIG. 8. As shown in FIG. 8, the potassium permanganate 810 and glycerin 840 are disposed on either side of a thin membrane 830. A user can rupture the membrane 830 by applying pressure thus allowing the potassium permanganate 810 and glycerin 840 to mix and contact the modified thermite fuel composition 820, thus initiating the desired thermite reaction.

A still further aspect of the present invention is integration of a heating element comprised of a modified thermite fuel composition and an activation mechanism into the packaging of a food product to be heated by a consumer. An appropriate design of package can be used in conjunction with the moderated composite fuel formulation to provide for ease of use and additional consumer safety. The solid-state fuel can be integrated into a package in a way that provides for efficient transfer of the heat generated to the material to be heated. To illustrate this aspect of the invention, several illustrative embodiments describing designs for incorporating solid fuel compositions into self-heating food packaging follow.

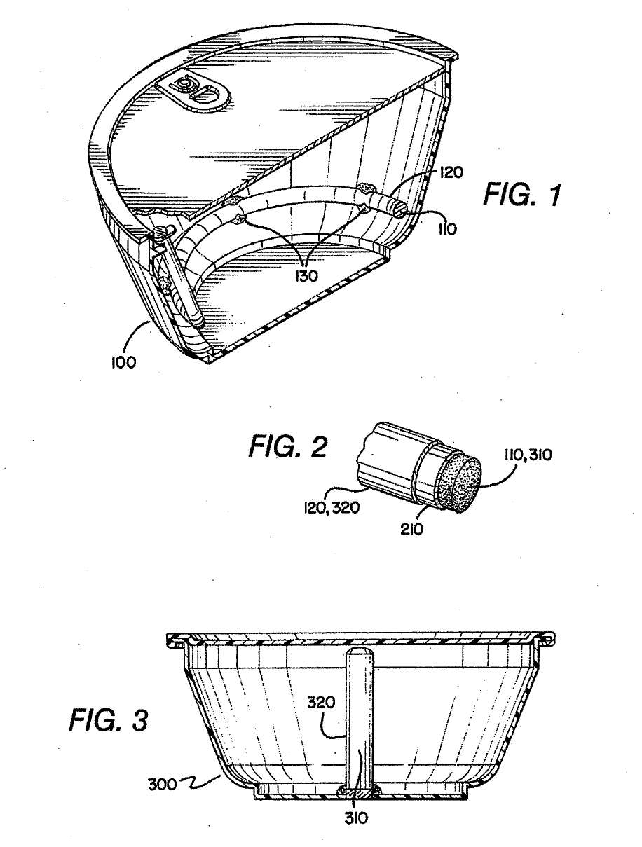

FIGS. 1 and 3 show heater device, apparatus, or package designs that are suited to heating foods with a high fluid content, such as canned soups or beverages. In FIG. 1, the fuel composite 110 is packed into a metal tube 120 that is formed into the shape of a complete or partial annular ring to provide a heating surface near the bottom of the container 100 while at least one end of the tube is located near the top of the container to allow access for user activation of the device. In the alternative design of FIG. 3 the fuel composite 310 is packed into a cylindrical metal can 320 which is then affixed to the bottom of the container 300. However, those of ordinary skill in the art will understand that a myriad of heater component shapes can be used without departing from the novel scope of the present invention.

In both designs, the thin metal wall enclosing the fuel provides excellent heat transfer to the surrounding fluid and the simple constructions are amenable to low cost methods of manufacture. As shown in FIG. 2, the tube 120 or cylinder 320 can be lined with a ceramic layer 210 to provide more efficient heat transfer through the metal wall. Various means can be provided for closing the open ends of the packed cylinders so that the fuel materials will not come into direct contact with the food. The packed tubing may be held in place by stand-off mechanical contacts 130, such as for example welded tabs to the interior of the container, so that heat transfers efficiently to the surrounding fluid and heat losses to the exterior food container wall are minimized. The heater elements can be offset from the center in order to facilitate filling, stirring, and spooning material from the container. Those of ordinary skill in the art will understand that numerous methods for attaching or integrating the heating component into the packaging structure are available without departing from the novel scope of the present invention.

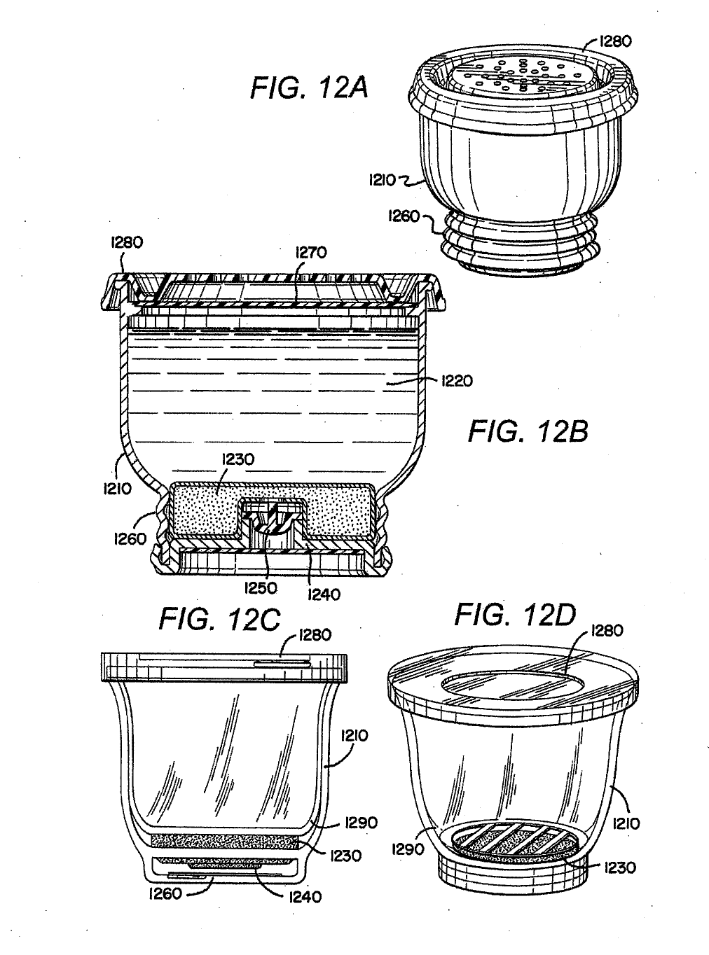

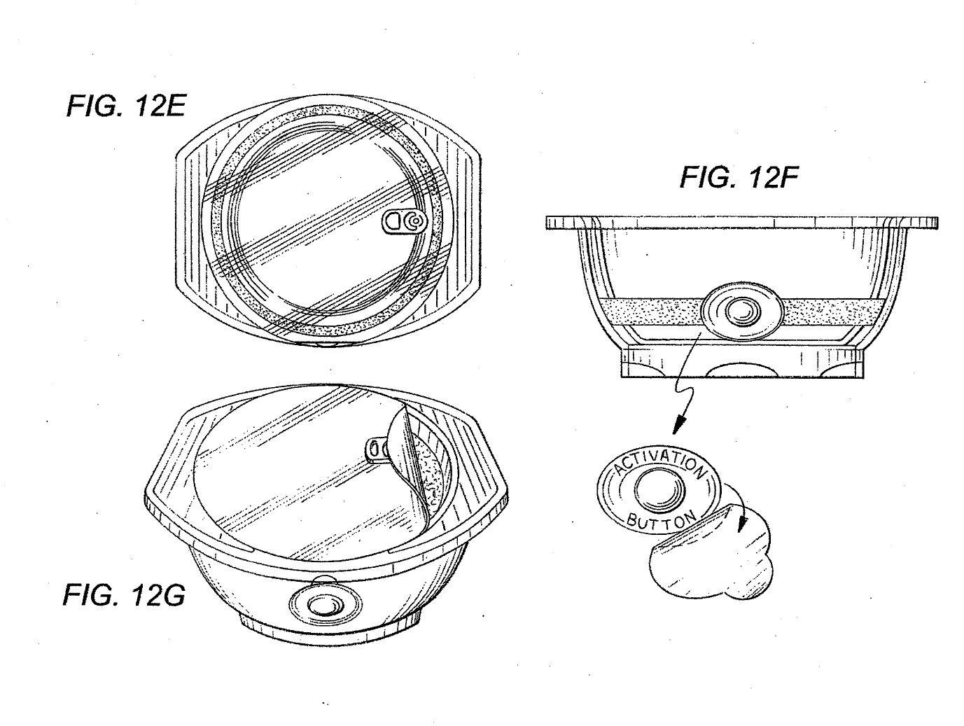

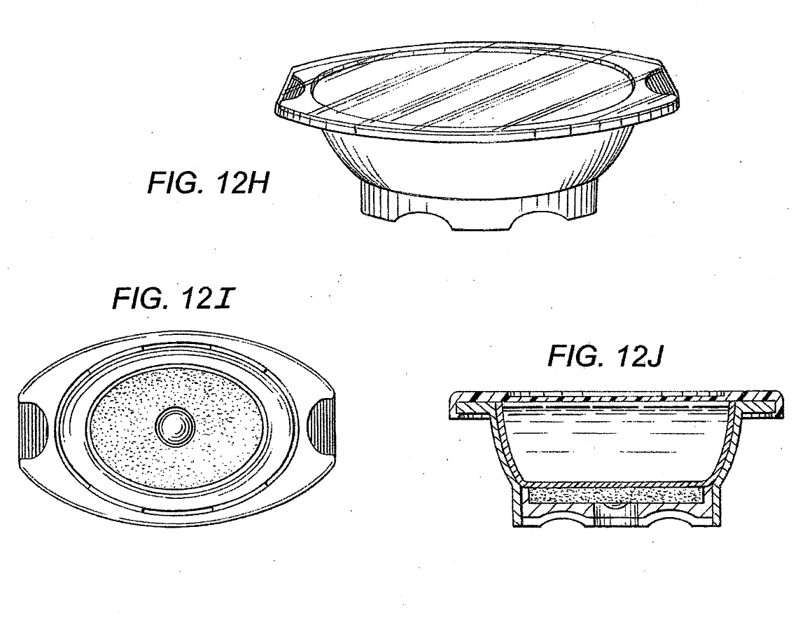

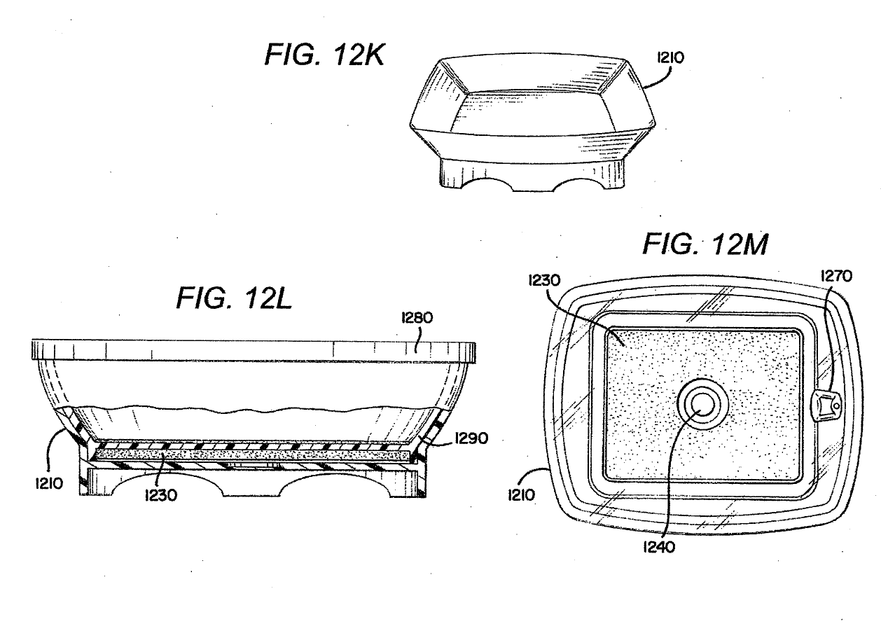

Further embodiments of this aspect can include the bowl configurations shown in FIGS. 12A-12M. As shown in FIGS. 12A-12D, a bowl 1210 that can be filled with the liquid or food to be heated 1220 has an amount of solid-state modified thermite fuel 1230 located in the bottom of the bowl 1210. However, as shown in FIGS. 12E-12G, the modified thermite fuel 1230 can be configured as a flat ring located in the interior of bowl 1210. The modified thermite fuel can be encapsulated to prevent contact with the liquid or food to be heated 1220. Alternatively, a liner 1290 may be placed into the interior of the bowl 1210 to prevent the modified thermite fuel 1230 from contacting the liquid or food to be heated 1220 as shown in FIGS. 12C and 12D. An activation device 1240 is disposed in contact with the modified thermite fuel 1230 such that a thermite reaction is triggered upon user actuation of the activation device 1240. The activation device 1240 is accessible by a user from the outside of the bowl 1210 and is covered by a safety seal 1250 which prevents inadvertent actuation of the activation device 1240 but can be removed by a user. Those of ordinary skill in the are will understand that safety seal 1250 can be comprised of various materials and be configured into a variety of shapes to correspond to a specific bowl geometry without departing from the novel scope of the present invention.

The outer wall of bowl 1210 can have a corrugated configuration 1260 to prevent heat transfer through certain sections of the bowl thereby controlling the heating profile of the liquid or food to be heated 1220 or preventing the user from being burned when touching the bowl 1210. The bowl 1210 is sealed at the top by a food seal 1270 that prevents the liquid or food to be heated 1220 from escaping or spoiling during storage or transport. Those of ordinary skill in the art will understand that the food seal 1270 may be comprised of a variety of materials and configurations without departing from the novel scope of the present invention. The bowl 1210 may also have a lid 1280. The lid 1280 may have ventilation holes to aid in the heating process and may also be configured with various shaped grooves or other shapes to allow multiple bowls 1210 to be stacked easily and efficiently for transportation or storage. Finally, those of ordinary skill in the art will understand that the bowl 1210 can be a variety of shapes and configurations to accommodate various types of liquids and foods including but not limited to the oblong configuration shown in FIGS. 12H-12J and the square configuration shown in FIGS. 12K-12M without departing from the novel scope of the present invention.

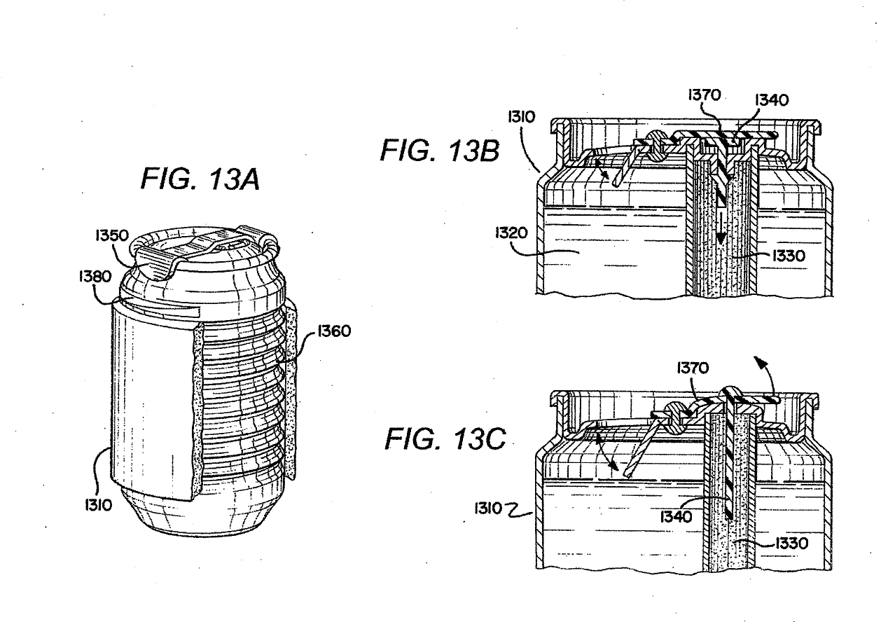

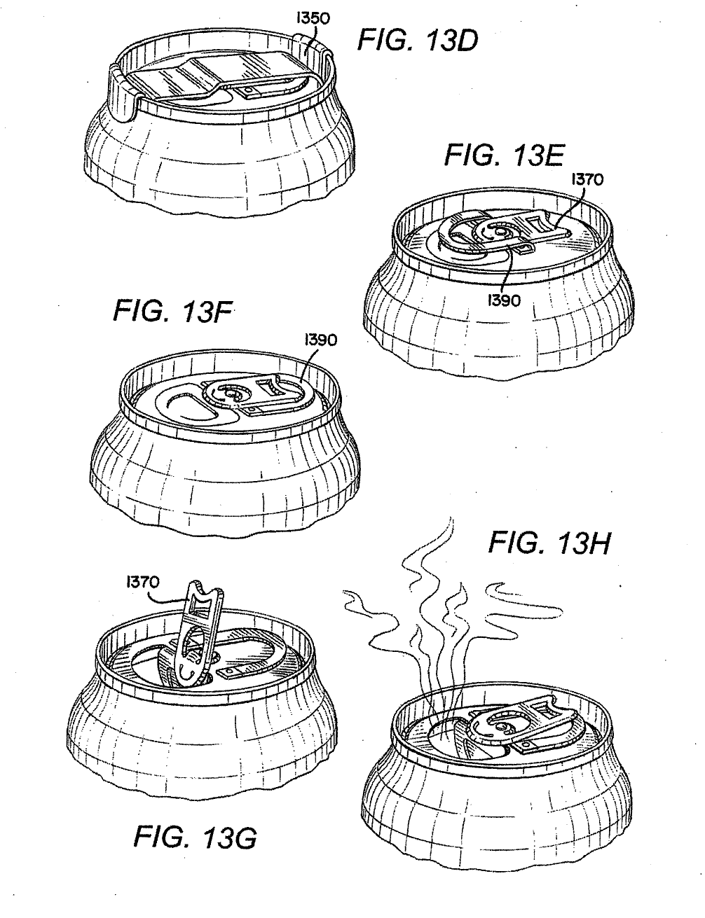

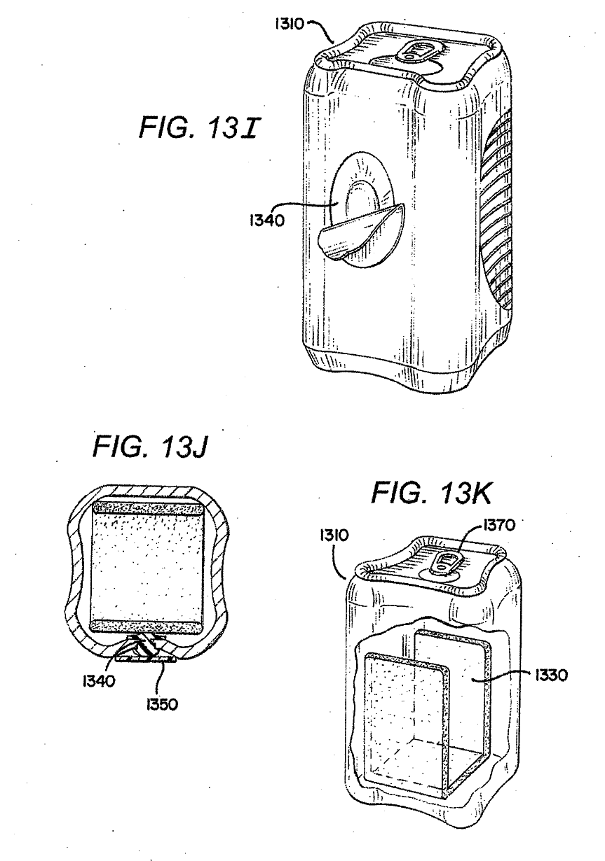

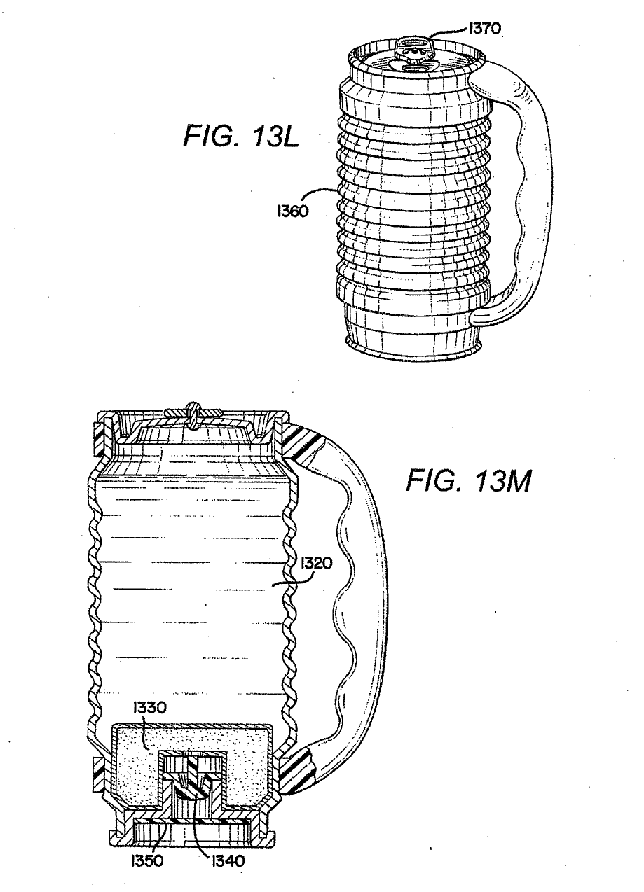

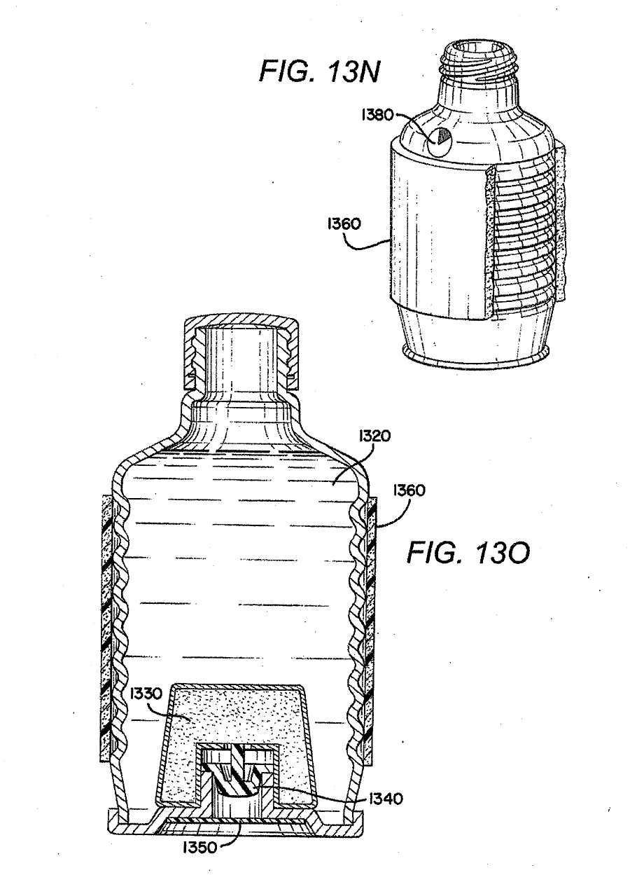

In another embodiment, shown in FIGS. 13A-130, an amount of solid-state modified thermite fuel 1330 is integrated into a beverage can 1310. As shown in FIG. 13A, the can 1310 may have corrugated sections 1360 to prevent the user from being burned and a temperature indicator 1380 to let the user know the temperature of the liquid 1320 inside the can 1310. The temperature indicator 1380 may be a sticker or decal that changes color at different temperatures. The can 1310 may also have a safety seal 1350 to prevent inadvertent activation of modified thermite fuel 1330. Those of ordinary skill in the art will understand that the can 1310 may be a variety of shapes, sizes and configurations including but not limited to the square configuration shown in FIGS. 13I-13K, the handled-mug configuration shown in FIGS. 13L and 13M and the bottle configuration shown in FIGS. 13N and 13O without departing from the novel scope of the present invention.

As shown in FIGS. 13B-13H, the can 1310 contains an encapsulated amount of modified thermite fuel 1330 in contact with an activation device 1340 that is integrated into the top of the can 1310. The activation device 1340 may function in a variety of ways to trigger a thermite reaction. As shown in FIG. 13B, the activation device 1340 is a push-button initially covered by opener tab 1370. A user can open the can 1310 with opener tab 1370 and then actuate activation device 1340 to heat the beverage 1320. As shown in FIG. 13C, the activation device is integrated into opener tab 1370 such that a user can simultaneously open the can 1310 and actuate the activation device 1340. As shown in FIGS. 13D-13H, the can 1310 may include a separate activation tab 1390 connected to the activation device 1340. A user can pull the activation tab 1390 first, allow the beverage 1320 to reach a desired temperature and then open the can with opener tab 1370. Those of ordinary skill in the art will understand that the activation device may be located at various places around the can 1310 including but not limited to the side of the can 1310 as shown in FIGS. 13I and 13J without departing from the novel scope of the present invention.

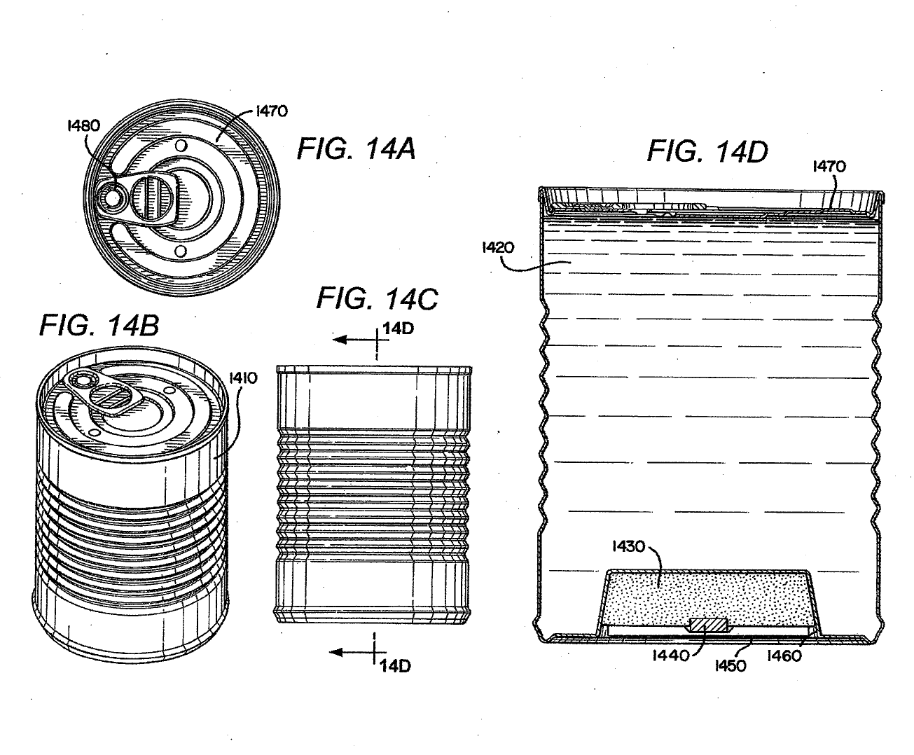

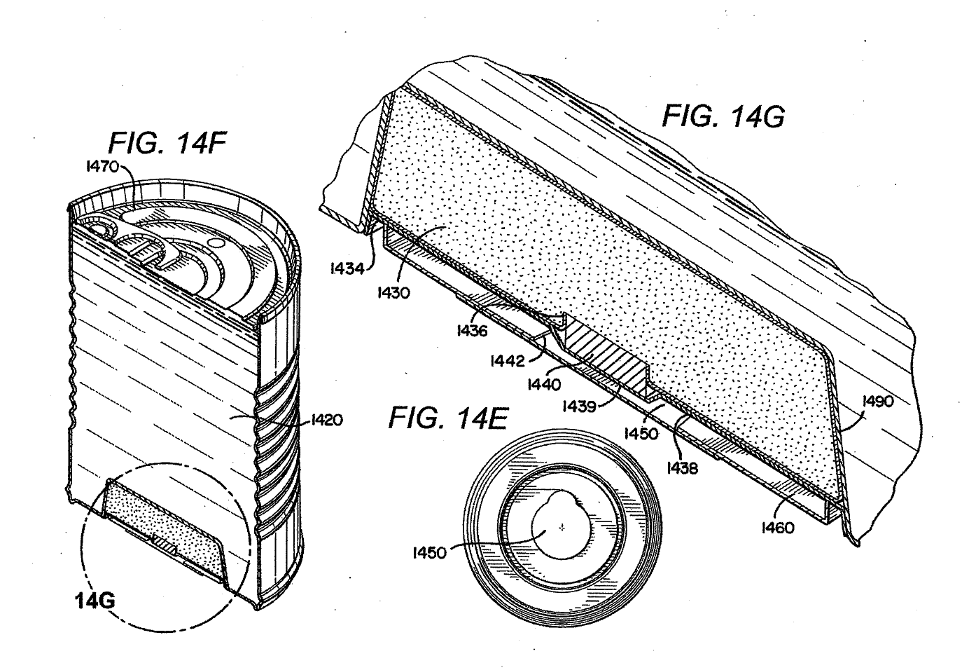

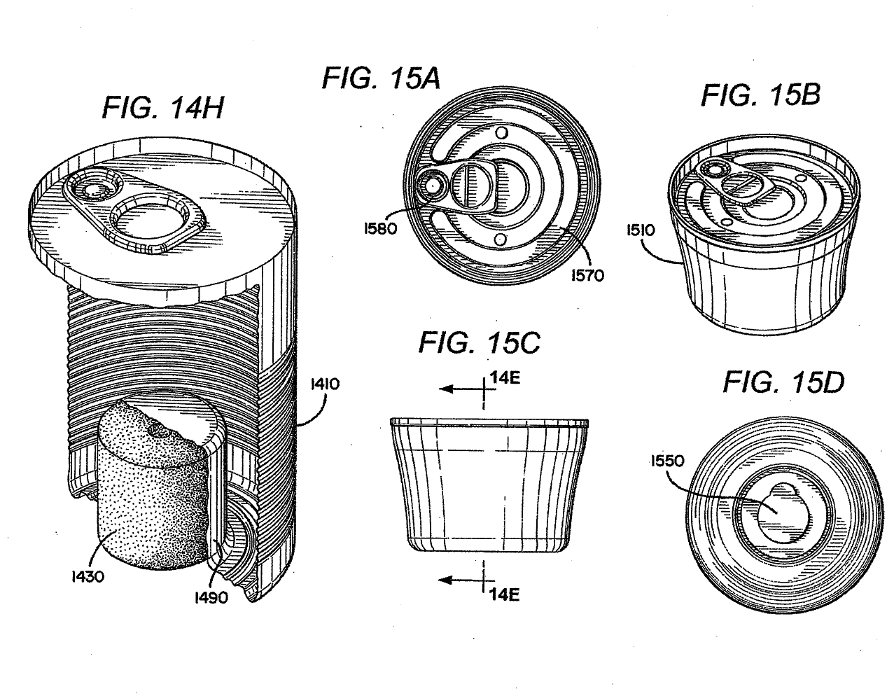

In another embodiment, shown in FIGS. 14A-14H, an amount of solid-state modified thermite fuel 1430 is integrated into a storage can 1410 for a food or liquid 1420. As shown in FIGS. 14A-14C, the storage can 1410 is sealed at the top by a removable lid 1470. An opener tab 1480 is integrated onto the removable lid 1470 to aid a user in opening the can 1410. As shown in FIGS. 14D and 14F-14G, the bottom of the storage can 1410 is formed with an indented groove or pocket 1490 that allows an amount of modified thermite fuel 1430 to be encapsulated inside the bottom of the storage can 1410. As best shown in FIGS. 14F and 14G, the modified thermite fuel is encapsulated within a fuel housing 1434 disposed within the pocket 1490, wherein the activation device 1440 is in communication with the modified thermite fuel 1430 via an aperture 1436 within the housing 1434. A cover 1438 retains the fuel housing 1434 and the activation device 1440 in place and provides a cover portion 1439 over the activation device 1440. The cover portion 1439 is configured to deflect and allow activation of the activation device 1440. An annular shroud 1460 is disposed adjacent to the cover 1438 and has an aperture 1442 therein to allow access to the cover portion 1439. A safety seal 1450 is disposed over the aperture 1442 to prevent access to the cover portion 1439 and accidental activation of the activation device 1440. As shown in FIG. 14G, those of ordinary skill in the art will understand that safety seal 1450 can be comprised of various materials and be configured into a variety of shapes without departing from the novel scope of the present invention. The annular shroud 1460 is preferably rigid in structure so that it cannot deflect inwardly toward the activation device 1440 and allow activation without removing the safety seal 1450. In an alternate embodiment, the annular shroud 1460 and cover 1438 are integrated into a single structure. The pocket 1490 can be trapezoidal to allow a disc-shaped modified thermite fuel 1430 to be situated therein. Those of ordinary skill in the art will also understand that the pocket 1490 can be a variety of shapes, sizes and configurations including but not limited to the cylindrical configuration shown in FIG. 14H without departing from the novel scope of the present invention.

Among others, an advantage of the embodiment depicted in FIG. 14D, wherein the fuel or fuel device is fully integrated or “built into” the packaging, is that there are fewer parts and material requirements for assembly. On the other hand, among others, an advantage of the embodiment depicted in FIG. 14G is that the fuel or fuel device is a discrete component, which may be encapsulated or have its own device structure and be utilized in a modular arrangement. One of ordinary skill in the art will recognize that each of the embodiments depicted and described herein may have unique characteristics or configurations that may translate into one or more advantages over other depicted and described embodiments depending on a particular application.

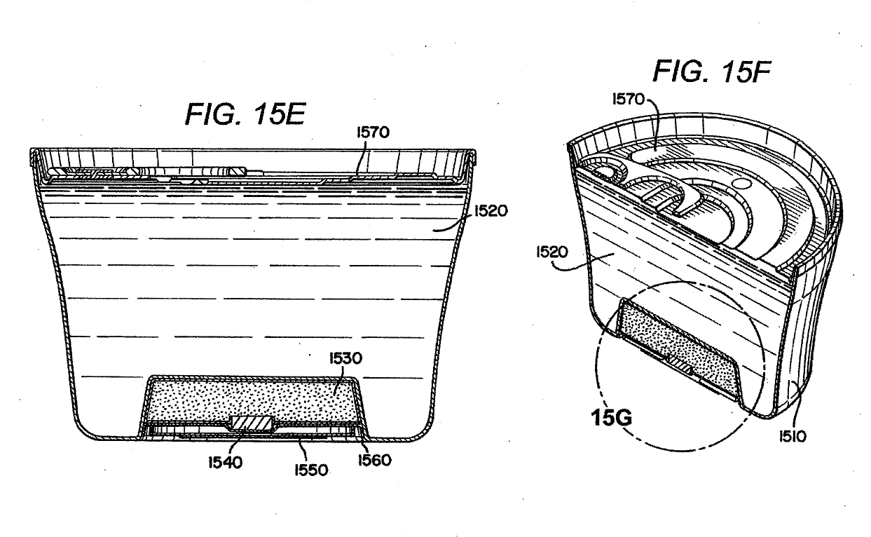

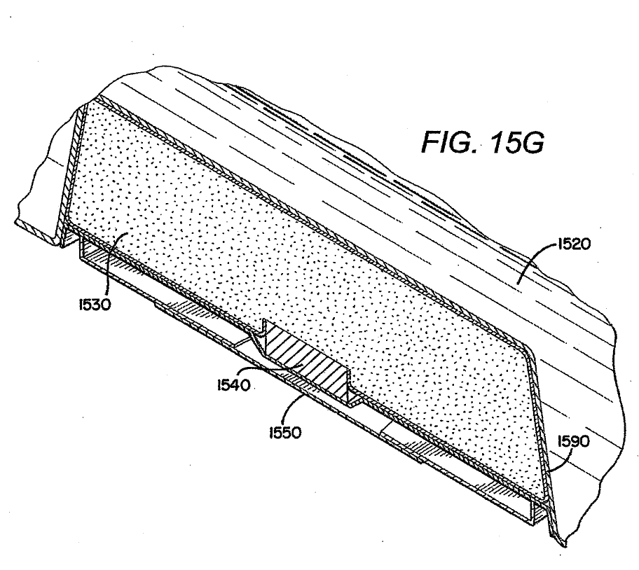

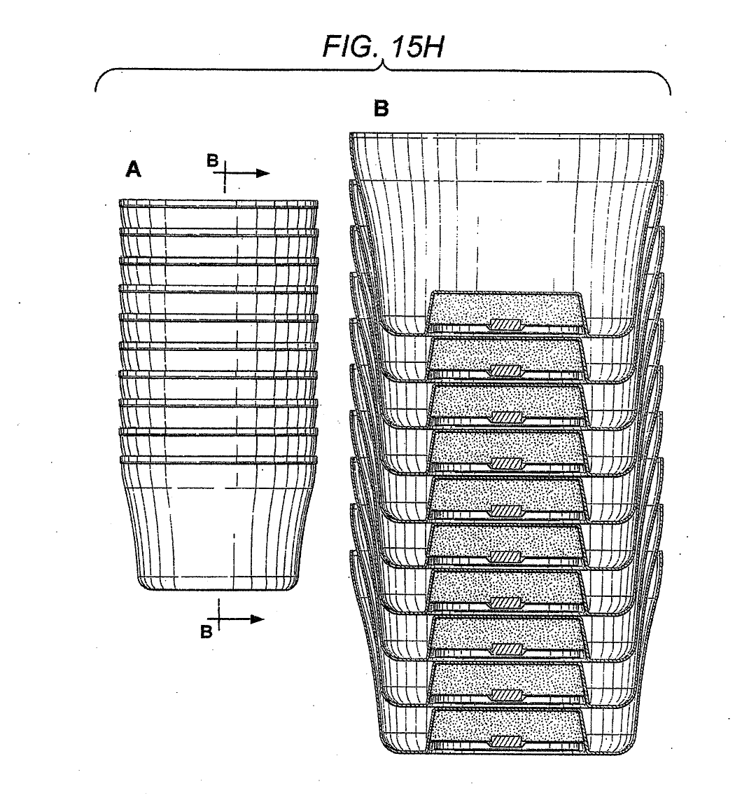

In another embodiment, shown in FIGS. 15A-15H, an amount of solid-state modified thermite fuel 1530 is integrated into a food container 1510 particularly suitable for a liquid food, such as soup 1520. As shown in FIGS. 15A-15C, the container 1510 is sealed at the top by a removable lid 1570. A opener tab 1580 is integrated onto the removable lid 1570 to aid a user in opening the container 1510. As shown in FIGS. 15E-15G, the bottom of the container 1510 is formed with an indented groove or pocket 1590 that allows an amount of modified thermite fuel 1530 to be encapsulated inside the bottom of the container 1510. The modified thermite fuel 1530 can be applied pre- or post-retort processing. The pocket 1590 can be trapezoidal to allow a disc-shaped modified thermite fuel 1530 to be situated therein without protruding outside the container 1510. This integration of the modified thermite fuel 1530 allows for multiple containers to be efficiently stacked during storage or transport as shown in FIG. 15H.

An activation device 1540 is located in contact with the modified thermite fuel 1530 such that a thermite reaction is triggered upon user actuation of the activation device 1540. As shown in FIG. 15G, the construction is similar to that shown in the embodiment of FIG. 14G. As shown in FIGS. 15D-15G, the activation device 1540 is accessible through an aperture in an annular shroud 1560 that is covered by a safety seal 1550 which prevents inadvertent actuation of the activation device 1540 but can be removed by a user. Those of ordinary skill in the art will understand that safety seal 1550 can be comprised of various materials and be configured into a variety of shapes without departing from the novel scope of the present invention.

Increased weight and volume of packaging relative to the net food content translates to higher shipping costs and shelf space requirements. Therefore, in order to keep packaging overhead low, a compact SHFP heater device is preferred. However, a compact geometry means less surface area is available for heat transfer, which can be an important consideration in cases where the food to be heated is not readily stirred to provide convective heat transfer. Conductive heat transfer from a small heater to a larger mass of solid or non-stirrable food material will provide inefficient and uneven heating.

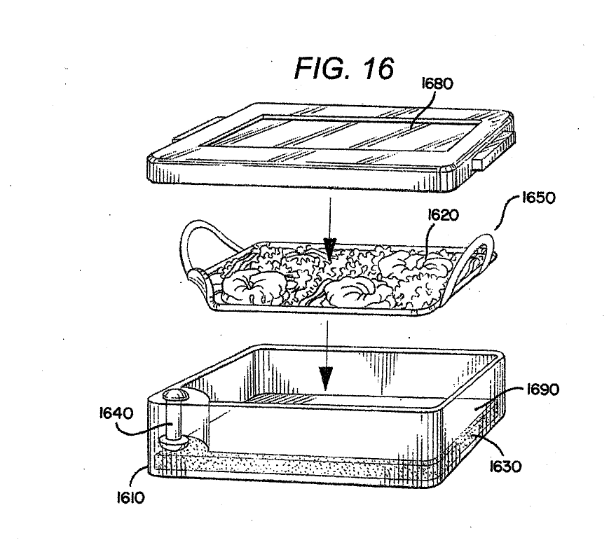

In order to overcome these limitations, the heater element of this invention may be implemented so that the heat it generates raises steam that distributes throughout the package interior and transfers sensible and latent heat (via condensation) to the food. An exemplary embodiment of this aspect of the present invention is shown in FIG. 16. A modified thermite fuel 1630 is layered in the bottom of a steamer pan 1610. An activation device 1640 is located in contact with the modified thermite fuel 1630 at one corner of the pan 1610. A liner 1690 is located on the interior of the pan 1610 to prevent the modified thermite fuel 1630 from contacting the food to be heated 1620. The food to be heated 1620 is placed on a steaming rack 1650 inside the pan 1610 and then covered with lid 1680. A user can then use the activation device 1640 to trigger the modified thermite fuel and steam the food 1620.

The principle of using a chemical reaction to raise steam for heat transfer is efficiently used in the “flameless ration heaters” (FRH) used by the US Army to heat the “meal ready to eat” (MRE) field ration. However, the FRH is a wet system based on mixing magnesium metal powder with water and is not well suited to widespread consumer use, whereas in the present invention, the water to be vaporized is not a component of the dry reaction mixture. Rather a small quantity of water is maintained in contact with the outer surface of the heater. For example, the cylindrical heater design of FIG. 3 could be wrapped in a dampened wicking material or located in a small condensate sump in the base of the package. The combustion characteristics of the heater are designed so that in operation, the exterior surface of the heater maintains a temperature sufficient to vaporize water to steam.

Applications of the present invention are not limited to the SHFP applications described above. A heating component in accordance with the present invention could be incorporated into a wide array of applications where heating would be desirable such as camping equipment as noted above or gloves for skiiers or mountain climbers.

While one or more specific embodiments have been illustrated and described in connection with the present invention, it is understood that the present invention should not be limited to any single embodiment, but rather construed in breadth and scope in accordance with recitation of the appended claims.

What is claimed is:

1. A heating device comprising:
a heating chamber defining an interior space for receiving and storing a substance to be heated;
a reaction chamber disposed adjacent to the interior space of the heating chamber;
a solid-state modified thermite reaction composition disposed within the reaction chamber such that it is physically isolated from and in thermal communication with the interior space of the heating chamber; and
an activator mechanism connected to either the reaction chamber or the heating chamber such that the activator mechanism is in communication with the reaction composition;
wherein the reaction composition is inert until the activator mechanism is actuated.

2. The device of claim 1 wherein the reaction chamber is comprised of a heat-conductive material.

3. The device of claim 2 wherein the heat-conductive material is aluminum.

4. The device of claim 1 wherein the reaction chamber is lined with ceramic.

5. The device of claim 1 wherein the reaction chamber is coated with an insulating material.

6. The device of claim 1 wherein the reaction chamber is substantially cylindrical in shape.

7. The device of claim 1 wherein the reaction chamber is substantially annular in shape.

8. The device of claim 1 wherein the activator mechanism comprises a battery powered wire.

9. The device of claim 1 wherein the activator mechanism comprises a piezoelectric spark ignitor.

10. The device of claim 1 wherein the activator mechanism comprises a plurality of reactive chemical compounds.

11. A heating device comprising:
a heating chamber defining an interior space for receiving and storing a substance to be heated;
a reaction chamber;
a solid-state modified thermite reaction composition disposed within the reaction chamber such that it is physically isolated from and in thermal communication with the interior space of the heating chamber; and
an activator mechanism affixed to either the reaction chamber or the heating chamber such that the activator mechanism is in communication with the reaction composition;
wherein the reaction composition is inert until the activator mechanism is actuated.

12. The device of claim 11 further comprising a liner disposed on the interior of the heating chamber that separates the heating chamber from the reaction chamber.

13. The device of claim 12 wherein the liner is comprised of a heat-conductive material.

14. The device of claim 11 further comprising a safety seal removably affixed to the outside of the heating chamber or reaction chamber such that the activator mechanism is prevented from being actuated.

15. The device of claim 11 wherein the heating chamber is bounded by a removably affixed lid element.

16. The device of claim 11 wherein the heating chamber is bounded by a lid element.

17. The device of claim 16 wherein the lid element can be punctured by an opener tab when the opener tab is pulled by the user.

18. The device of claim 17 wherein the activator mechanism is integrated into the opener tab such that a user can simultaneously open the heating chamber and trigger the reaction composition.

19. The device of claim 11 wherein the reaction chamber is molded into a wall of the heating chamber.

20. A method for heating a food or liquid comprising the steps of:
obtaining a container having a solid-state modified thermite reaction composition, an activation mechanism in contact with the reaction composition and a temperature indicator;
placing a food or liquid into the container;
actuating the activation mechanism;
observing the temperature indicator until a desired temperature is indicated; and
removing the food or liquid from the container.
